(19) United States
(12) Patent Application Publication
(10) Pub. No.: US 2007/0000446 A1
(43) Pub. Date: Jan. 4, 2007

(54) System for handling and disposing of pet waste

(76) Inventors: Steven B. Dunn, Beverly Hills, CA (US); Mark Hatherill, Manhattan Beach, CA (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(21) Appl. No.: 11/173,269

(22) Filed: Jul. 1, 2005

(51) Int. Cl. A01K 29/00

(52) U.S. Cl. 119/161

(57) ABSTRACT

A disposable pad for use with pets is compact, simple to use and promotes improved hygiene in handling pet waste. The pad has an absorbent top layer and a bottom layer that is fabricated from a nonabsorbent material such as plastic. A pouch is located at one side of the disposable pad. After an animal relieves itself on the absorbent layer, the pad is folded and rolled into a compact shape. It is then placed within the pouch for disposal.

### BACKGROUND OF THE INVENTION

1. Field of the Invention

The invention relates to the field of pet and animal products. In particular the invention relates to disposable pads for pets.

2. Description of the Related Technology

Housebreaking pets is a difficult task and involves the unpleasant task of handling the waste products of animals. Traditional methods for house training dogs involved the use of newspapers, pads and other products in order to prevent the waste material from ruining carpeting or floors. However these methods of preventing unwanted waste material from ruining floors frequently required a clean-up process that was just as prone to cause accidents. A pet owner frequently ran the risk of coming into contact with the waste material when cleaning up the mess. This was both unsanitary and unpleasant. Furthermore, disposal of the used newspapers or pads also could result in unwanted messes.

Although waste disposal products have been developed that have addressed some of the above problems, they do not provide a simple and effective system for disposing of the products that is hygienic and easy to use. Even when providing disposal enclosures such as bags along with such products, problems still arise. These products typically do not provide a clear way of indicating the location of disposable bags for storage of the used products or provide a compact method of disposing of soiled pads and waste material.

Therefore, there exists a need for providing a compact and simple method and apparatus for disposing of pads used for the collection of animal waste material.

### SUMMARY OF THE INVENTION

Accordingly, it is an object of certain embodiments of the invention to provide a compact and simple method and apparatus for disposing of pads used for the collection of animal waste material.

In a first aspect, the present invention relates to a disposable pad for use with pets having a first surface made of an absorbent material. The disposable pad also has a second surface made of a non-absorbent material and a pouch attached to the second surface, wherein a peripheral edge of the pouch extends further than a peripheral edge of the first surface.

In a second aspect, the present invention relates to a method for using a disposable pad having the steps of providing a disposable pad having a first surface made of an absorbent material and a second surface made of a non-absorbent material, and a pouch attached to the second surface, wherein a peripheral edge of the pouch extends further than a peripheral edge of the first surface. The method further has the steps of folding the second surface on top of the first surface after the first surface has been soiled by an animal, folding the pouch over to the first surface and rolling the first surface and the second surface into the pouch.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 shows the first and second surfaces of the disposable pad.

FIG. 2 shows the disposable pad folded into its first position when preparing to dispose of the pad.

FIG. 3 shows the disposable pad folded into its second position when preparing to dispose of the pad.

FIG. 4 shows the disposable pad folded into its third position when preparing to dispose of the pad.

FIG. 5 shows the disposable pad folded into its fourth position when preparing to dispose of the pad.

FIG. 6 shows a front view of a second embodiment of the disposable pad that is circular in shape.

FIG. 7 shows a rear view of a second embodiment of the disposable pad that is circular in shape.

### DETAILED DESCRIPTION OF THE PREFERRED EMBODIMENT(S)

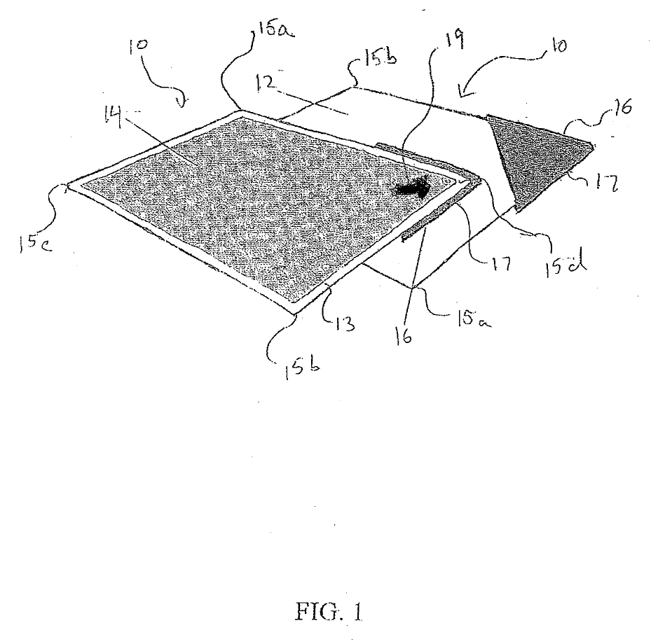

Referring now to the drawings, wherein like reference numerals designate corresponding structure throughout the views, and referring in particular to FIG. 1, a disposable pad 10 that is constructed according to a preferred embodiment of the invention is shown.

FIG. 1 shows top and bottom sides of disposable pad 10. The top side 14 is fabricated from an absorbent material such as a hydrophilic polymer that turns into a gel material upon coming into contact with a liquid. Usage of the hydrophilic material further assists in preventing the accidental spillage of waste material since the gel form avoids the problems caused by having any residual liquid waste. Alternatively, the absorbent material may be constructed out of a non woven or laminate cotton, or cotton fiber. Absorbent top surface 14 is constructed and arranged to absorb liquid animal waste products such as urine. Absorbent surface 14 may also be scented in order to cover up the odors of any waste material, it may also be treated with pheromones in order to attract animals to the pad. The bottom side 12 is preferably fabricated from a nonabsorbent material, such as a polyethylene or polypropylene resin or any other material that is non-absorbent. Non-absorbent bottom surface 12 prevents animal liquid waste from leaking through the absorbent material 14 onto the floor; it also provides a non-contaminated surface area that a person disposing of pad 10 may grasp. Attached to non-absorbent surface 12 is a pouch 16 that is formed so that it is foldable over to the top side 14. Pouch 16 is also preferably made of a non-absorbent material.

The side of the non-absorbent surface 12 that is opposite from the side visible when viewing pad 10 from the bottom may form a border 13 around absorbent surface 14. This can be accomplished by having bottom surface 12 larger in area than absorbent surface 14. When absorbent surface 14 is attached to non-absorbent surface 12 the peripheral edge of non-absorbent surface 12 forms the border 13. Border 13 has four corners 15a-15d in the embodiment that is shown in FIG. 1. In alternative embodiments, border 13 may be made of a separate material from the nonabsorbent surface 12 and placed on top of absorbent layer 14 or non-absorbent layer 12. Additionally it may have a textured surface in order to assist in gripping and handling of the disposable pad 10 during disposal. It is possible to have no border 13, however having border 13 provides a suitable area to grasp during the preparation for disposal.

Pouch 16 is preferably foldably attached to non-absorbent surface 12 in such a way that pouch edge 17 extends beyond the peripheral edge of non-absorbent layer 12. In doing so, the outer peripheral edge of the pouch 16 will form part of the overall outer peripheral edge of the disposable pad 10. Pouch 16 is preferably attached to the disposable pad 10 in a location that is proximate to the outer peripheral edge thereof. Disposable pad 10 is preferably polygonal in shape, having a plurality of corners, and pouch 16 is preferably attached proximate to one of the corners. In the preferred embodiment, disposable pad 10 is substantially rectangular, and pouch 16 is attached proximate to one of the corners of the rectangular shape.

Pouch 16 is further preferably triangular in shape and when viewed from the bottom side covers the corner 15d of pad 10. When pad 10 is viewed from the top side, pouch edge 17 will be visible adjacent to corner 15d of pad 10. The visibility of pouch edge 17 constitutes visual indicium that enables a pet owner to easily determine where pouch 16 is located. This prevents any unnecessary fumbling around with disposable pad 10 to locate pouch 16. There may also be additional or alternative visual indicia, such as dots, arrows, or writing, provided on border 13 or absorbent surface 14 in order to indicate where pouch 16 is located. In FIG. 1, visual indicium 19 in the form of an arrow placed upon absorbent surface 14. Pouch 16 may also be scented in order to help cover up the odor of waste material that is placed within it.

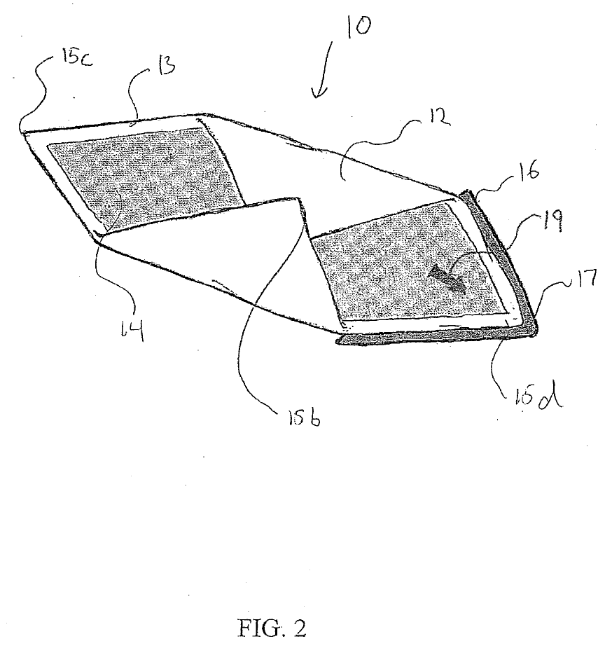

FIG. 2 shows disposable pad 10 in the first step of preparation for disposal. After a pet soils absorbent surface 14, corners 15a and 15b of pad 10 are folded in towards the center of pad 10. Corners 15a and 15b are the two corners adjacent to pouch 16 and are opposing each other. Corners 15a and 15b are folded in towards each other so that one corner will overlap the other. In FIG. 2, corner 15b overlaps corner 15a. The folding operation will bring non-absorbent surface 12 to rest on top of absorbent surface 14 and therefore prevent the person folding pad 10 from coming into contact with the soiled material. The two corners should be folded in so that the sides of pad 10 are the same width as the opening of pouch 16 in order to facilitate the rolling process discussed below.

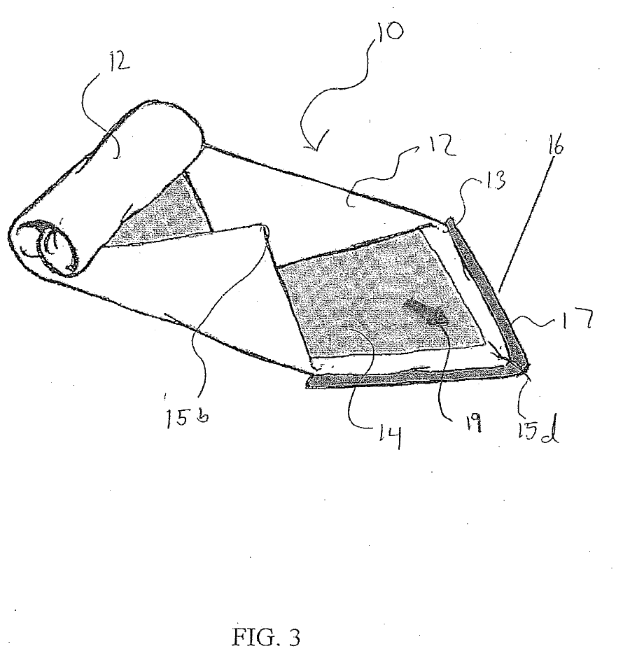

FIG. 3 shows disposable pad 10 in the second step of preparation for disposal. The remaining corner of pad 10, corner 15c, which is located opposite corner 15d, is rolled in towards the center of pad 10. The rolling motion is done so that the person rolling pad 10 is only contacting non-absorbent surface 12.

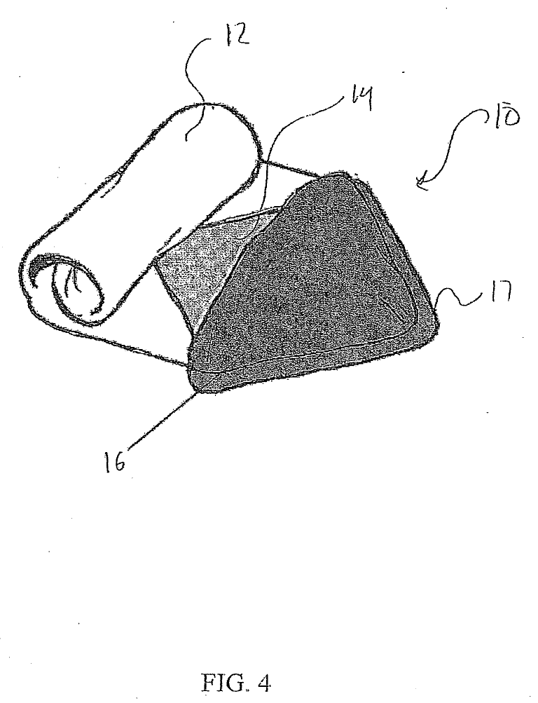

FIG. 4 shows disposable pad 10 in the third step of preparation for disposal. In this stage of preparation, pouch 16 is folded over to the top side of pad 10. This is accomplished by flipping pouch 16 so that the opening of pouch 16 receives corner 15d and that portion of absorbent surface 14 located adjacent to corner 15d. Alternatively, absorbent surface 14 and border 13 may form the inside of pouch 16, and pouch 16 may be turned inside out. The remainder of pad 10 is then further rolled towards the opening of pouch 16.

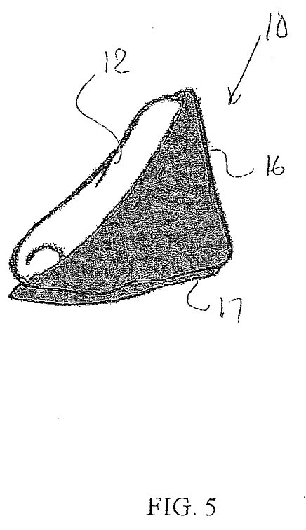

FIG. 5 shows disposable pad 10 in the fourth step of preparation for disposal. In this step the remainder of pad 10 is placed within pouch 16. Pouch 16 may have structure for sealing it, such as a plastic seal or an adhesive layer. The pouch 16 containing the absorbent surface 14, the waste product and the non-absorbent surface 14 is then disposed of.

An alternative method for preparing pad 10 for disposal involves first folding pouch 16 over to the top side of pad 10. Corners 15a and 15b are then gripped and folded in order to form a funnel shape. This assists in directing any solid waste material present into pouch 16. After funneling the waste material into pouch 16, corners 15a and 15b are folded in towards each other and corner 15c may be folded on top of them. Pad 10 may then be rolled into pouch 16 and pouch 16 can then be thrown away.

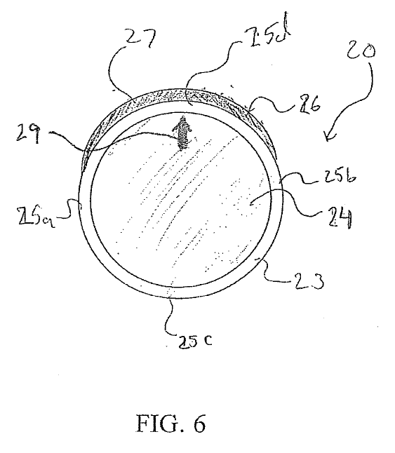

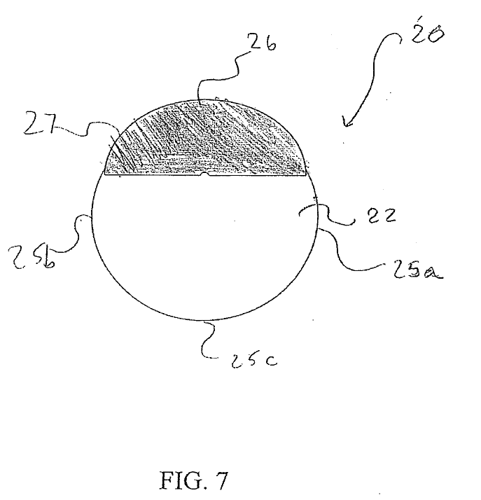

Additional shapes and configurations are possible for the two surfaces and the pouch. The shapes are not limited to being rectangular and triangular, although these shapes assist in facilitating the ease of folding and disposable. An alternative embodiment is shown in FIGS. 6 and 7 that illustrates a different possible shape and configuration for the disposable pad.

FIG. 6, shows a top side of a disposable pad 20 that has a circular form. Absorbent layer 24 functions in the same way as absorbent layer 14. Pad 20 has a border 23 made of non-absorbent material. Pouch edge 27 of pouch 26 is located adjacent arc apex 25d and is visible when looking at the topside of pad 20 in order to provide indication of where pouch 26 is located. Visual indicium 29, in the form of an arrow, is located on absorbent layer 24. Arc apexes 25a, 25b, and 25c are also shown and are used to perform the same functions as corners 15a-15c respectively.

FIG. 7 shows the bottom side of pad 20. Non-absorbent surface 22 forms the bottom side of pad 20 and has pouch 26 attached to it. Pouch 26 is semi-circular shaped and folded over to the topside during preparation for disposal, much in the same manner as pouch 10.

Preparation for disposal of pad 20 is accomplished in the same manner as pad 10, however instead of folding corners, the Arc apexes 25a and 25b are used to fold semi-circular sections of pad 20 towards the center. Apex 25c is then used to initiate the rolling process. The nonabsorbent layer 22 and absorbent layer 24 of pad 20 are eventually placed within pouch 26 and the entirety is disposed of.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A disposable pad for use with pets, comprising:
a first surface made of an absorbent material;
a second surface made of a non-absorbent material; and
a pouch attached to one of said first and second surfaces, and
a visual indicator providing an indication as to where said pouch is located.

2. The disposable pad of claim 1, wherein said first surface is substantially rectangular in shape.

3. The disposable pad of claim 2, wherein said second surface is substantially rectangular in shape.

4. The disposable pad of claim 3, wherein said pouch is substantially triangular in shape.

5. The disposable pad of claim 1, wherein said non-absorbent material is a plastic.

6. The disposable pad of claim 1, wherein said first surface is foldable into said pouch.

7. The disposable pad of claim 1, wherein a peripheral edge of said pouch extends further than a peripheral edge of said first surface.

8. The disposable pad of claim 7, wherein a peripheral edge of said second surface extends further than a peripheral edge of said first surface.

9. The disposable pad of claim 8, wherein said peripheral edge of said pouch extends further than said peripheral edge of said second surface.

10. The disposable pad of claim 1, wherein said first surface is substantially circular in shape.

11. The disposable pad of claim 1, wherein said pouch is attached to said second surface.

12. The disposable pad of claim 1, wherein said visual indicator is an arrow located proximate to said pouch.

13. A disposable pad for use with pets, comprising:
a first surface made of an absorbent material;
a second surface made of a non-absorbent material; and
a pouch attached to one of said first and second surfaces at a location that is proximate to an outer peripheral edge of said pad.

14. The disposable pad of claim 13, wherein said first surface is substantially rectangular in shape.

15. The disposable pad of claim 14, wherein said second surface is substantially rectangular in shape.

16. The disposable pad of claim 15, wherein said pouch is substantially triangular in shape.

17. The disposable pad of claim 13, wherein said non-absorbent material is a plastic.

18. The disposable pad of claim 13, wherein said first surface is foldable into said pouch.

19. The disposable pad of claim 13, wherein a peripheral edge of said second surface extends further than a peripheral edge of said first surface.

20. The disposable pad of claim 19, wherein said peripheral edge of said pouch extends further than said peripheral edge of said second surface.

21. The disposable pad of claim 13, wherein said first surface is substantially circular in shape.

22. The disposable pad of claim 13, wherein said pouch is attached to said second surface.

23. The disposable pad of claim 13, wherein said pad has a polygonal shape, and said pouch is attached to said pad near a corner of said polygonal shape.

24. The disposable pad of claim 23, wherein said pad is shaped as a rectangle, and said pouch is attached to said pad near a corner of the rectangle.

25. The disposable pad of claim 13, wherein said pouch as an outer periphery, and wherein said outer periphery of said pouch defines part of the outer periphery of said pad.

26. A method for using a disposable pad comprising steps of:
providing a disposable pad comprising;
a first surface made of an absorbent material;
a second surface made of a non-absorbent material; and
a pouch attached to one of said first and second surfaces;
folding said second surface on top of said first surface after said first surface has been soiled by an animal;
folding said pouch over to said first surface; and
rolling said first surface and said second surface into said pouch.

27. The method of claim 26, wherein said first surface is substantially rectangular in shape.

28. The method of claim 27, wherein said second surface is substantially rectangular in shape.

29. The method of claim 28, wherein said pouch is substantially triangular in shape.

30. The method of claim 26, wherein said non-absorbent material is a plastic.

31. The method of claim 26, wherein a peripheral edge of said second surface extends further than a peripheral edge of said first surface.

32. The method of claim 31, wherein said peripheral edge of said pouch extends further than said peripheral edge of said second surface.

33. The method of claim 26, wherein said first surface is substantially circular in shape.
